(19) United States
(12) Patent Application Publication
(10) Pub. No.: US 2025/0034393 A1
(43) Pub. Date: Jan. 30, 2025

(54) THERMOPLASTIC MIXTURES

(71) Applicant: BASF SE, Ludwigshafen (DE)

(72) Inventors: Erik Gubbels, Ludwigshafen (DE); Maximilian Lehenmeier, Ludwigshafen (DE); Rainer Klenz, Hassloch (DE)

(21) Appl. No.: 18/711,143

(22) PCT Filed: Nov. 11, 2022
(86) PCT No.: PCT/EP2022/081683

§ 371 Date: May 17, 2024

(30) Foreign Application Priority Data
Nov. 22, 2021 (EP) 21209466.8

(51) Int. Cl. C08L 67/02; B29C 49/00; B29K 23/00; B29K 67/00; B29K 105/00

(52) U.S. Cl. CPC C08L 67/02; B29C 49/0005; B29K 2023/065; B29K 2067/006; B29K 2105/0088; B29K 2995/0012; C08L 2203/30; C08L 2205/025; C08L 2205/035; C08L 2207/062; C08L 2207/322

(57) ABSTRACT

Thermoplastic mixtures comprising:
A) 30% to 100% by weight of a thermoplastic blend consisting of:
   A-1) 65% to 75% by weight of a polyester,
   A-2) 5% to 25% by weight of an HD or LD polyethylene,
   A-3) 3% to 10% by weight of an ionomer composed of at least one copolymer of:
      3-1) 30% to 99% by weight of ethylene
      3-2) 0% to 60% by weight of one or more compounds selected from the group consisting of 1-octene, 1-butene and propylene and
      3-3) 0.01% to 50% by weight of one or more functional monomers selected from the group consisting of carboxylic acids, carboxylic anhydrides and carboxylic esters with the proviso that the proportion of carboxylic acids is 30% to 100% by weight, the proportion of carboxylic anhydrides and/or carboxylic esters is complementarily 0% to 70% by weight and the hydrogen of the carboxyl groups of the carboxylic acids is replaced by a metal selected from the group consisting of sodium, potassium and zinc in a proportion of at least 20% (“mol %”) of the total number of carboxyl groups,
   wherein the proportions of components 3-1, 3-2 and 3-3 sum to 100% by weight,
   A-4) 0.5% to 5% by weight of an epoxidized oil or oil mixture, in which the at least partially unsaturated fatty acids in the underlying fatty acid esters of the oil or oil mixture have 12 to 22 carbon atoms,
   wherein the proportions of components A-1, A-2, A-3 and A-4 sum to 100% by weight of component A),
B) 0 to 70% by weight of further additives,
wherein the proportions of components A) and B) sum to 100% by weight.

The invention relates to thermoplastic mixtures comprising:
A) 30% to 100% by weight of a thermoplastic blend consisting of:
   A-1) 65% to 75% by weight of a polyester,
   A-2) 5% to 25% by weight of an HD or LD polyethylene,
   A-3) 3% to 10% by weight of an ionomer composed of at least one copolymer of:
      3-1) 30% to 99% by weight of ethylene
      3-2) 0% to 60% by weight of one or more compounds selected from the group consisting of 1-octene, 1-butene and propylene and
      3-3) 0.01% to 50% by weight of one or more functional monomers selected from the group consisting of carboxylic acids, carboxylic anhydrides and carboxylic esters with the proviso that the proportion of carboxylic acids is 30% to 100% by weight, the proportion of carboxylic anhydrides and/or carboxylic esters is complementarily 0% to 70% by weight and the hydrogen of the carboxyl groups of the carboxylic acids is replaced by a metal selected from the group consisting of sodium, potassium and zinc in a proportion of at least 20% (“mol %”) of the total number of carboxyl groups,
   wherein the proportions of components 3-1, 3-2 and 3-3 sum to 100% by weight,
   A-4) 0.5% to 5% by weight of an epoxidized oil or oil mixture, in which the at least partially unsaturated fatty acids in the underlying fatty acid esters of the oil or oil mixture have 12 to 22 carbon atoms,
   wherein the proportions of components A-1, A-2, A-3 and A-4 sum to 100% by weight of component A),
B) 0 to 70% by weight of further additives,
   wherein the proportions of components A) and B) sum to 100% by weight.

The invention further relates to moldings and hollow bodies produced using the thermoplastic mixtures and in particular hollow bodies produced by blow molding processes using the thermoplastic mixtures.

The production of hollow bodies and moldings from thermoplastic plastics generally employs mixtures comprising thermoplastic plastics, such as PET or PBT for example. In order for these mixtures to meet the requirements of the respective forming process they must inter alia have certain rheological properties. What is important here is a good balance between strength and toughness on the one hand and sufficient flowability to achieve the best possible filling of the mold on the other hand.

The publications of M. Joshi et al., Journal of Applied Polymer Science, Vol. 43, 311-328, 1991 (“D1”), M. Joshi et al., Journal of Applied Polymer Science, Vol. 45, 1837-1847 1992 (“D2”) and M. Joshi et al., POLYMER Volume 35, Number 17, 3679-3685, 1994 (“D3”) examine blends of PBT and HDPE and the effect of ionomers on the miscibility of the two plastics. When PBT and HDPE alone form biphasic mixtures, the addition of the ionomer (an ethylene-methacrylic acid copolymer with partial replacement of the acidic hydrogen with sodium) increases the compatibility of the rather polar PBT and non-polar HDPE, with novel properties of the ternary mixture. Accordingly the degree of dispersion of the HDPE in the PBT increases, the crystallization rate of the PBT increases with increasing proportion of ionomer and altogether the ternary phase of HDPE, PBT and ionomer may be regarded as a uniform alloy phase.

The publication WO 1990/14391 A1 (“D4”) claims mixtures of (i) polyesters, (ii-i) either sodium or potassium salts of carboxylic acids having 7-25 carbon atoms or (ii-ii) sodium or potassium salts of ionic copolymers of α-olefins comprising 2-5 carbon atoms and a, #-ethylenically unsaturated carboxylic acids comprising 3-5 carbon atoms and (iii) polyolefins having a weight-average molecular weight of 1000-20 000. According to D4, these mixtures are characterized by elevated impact strength.

The prior European Patent Application 20190021.4 (“D5”) claims thermoplastic blends which comprise polyesters, HD or LD polyethylene, an ionomer of at least one copolymer of ethylene, compounds selected from the group consisting of 1-octene, 1-butene and propylene and functional monomers from the group consisting of carboxylic acids, carboxylic anhydrides and carboxylic esters and optionally also further additives.

However, the admixture of epoxidized oils or oil mixtures has not been described in the prior art described above.

It is accordingly an object of the present invention to provide thermoplastic mixtures which are suitable for producing hollow bodies and moldings and whose composition on the one hand makes it possible to establish a good balance between flowability, viscosity and crystallization rate and on the other hand results in the required strength and impact toughness in the manufactured hollow bodies and moldings.

The inventors have accordingly found the thermoplastic mixture defined at the outset.

Preferred embodiments are apparent from the subsidiary claims.

As component A the thermoplastic mixtures according to the invention comprise 30% to 100% by weight of a thermoplastic blend consisting of:
A) 30% to 100% by weight of a thermoplastic blend consisting of:
A-1) 65% to 75% by weight of a polyester,
A-2) 5% to 25% by weight of an HD or LD polyethylene,
A-3) 3% to 10% by weight of an ionomer composed of at least one copolymer of:
   3-1) 30% to 99% by weight of ethylene
   3-2) 0% to 60% by weight of one or more compounds selected from the group consisting of 1-octene, 1-butene and propylene and
   3-3) 0.01% to 50% by weight of one or more functional monomers selected from the group consisting of carboxylic acids, carboxylic anhydrides and carboxylic esters with the proviso that the proportion of carboxylic acids is 30% to 100% by weight, the proportion of carboxylic anhydrides and/or carboxylic esters is complementarily 0% to 70% by weight and the hydrogen of the carboxyl groups of the carboxylic acids is replaced by a metal selected from the group consisting of sodium, potassium and zinc in a proportion of at least 20% (“mol %”) of the total number of carboxyl groups,
wherein the proportions of components 3-1, 3-2 and 3-3 sum to 100% by weight,
A-4) 0.5% to 5% by weight of an epoxidized oil or oil mixture, in which the at least partially unsaturated fatty acids in the underlying fatty acid esters of the oil or oil mixture have 12 to 22 carbon atoms,
wherein the proportions of components A-1, A-2, A-3 and A-4 sum to 100% by weight of component A).

Summing to 100% by weight the thermoplastic mixtures also comprise further additives as components B in a proportion of 0% to 70% by weight.

Preferred thermoplastic mixtures comprise component A-1 in a proportion of 68% to 73% by weight, component A-2 in a proportion of 18% to 22% by weight, component A-3 in a proportion of 5% to 10% by weight and component A-4 in a proportion of 2% to 5% by weight.

It is noted here that a specific polyester, a specific HD or LD polyethylene and a specific ionomer reactant are typically employed as components A-1, A-2 and A-3. However, it is also possible to employ mixtures of such polyesters, HD or LD polyethylene and ionomer reactants. It is further also noted (though this is familiar to those skilled in the art) that even a specific polyester, HD or LD polyethylene or ionomer reactant per se inherently represents a mixture of the respective polyester, HD or LD polyethylene or ionomer reactants as a result of the molar mass distribution that is a consequence of production.

Employed polyesters A-1 are generally based on aromatic dicarboxylic acids and an aliphatic or aromatic dihydroxy compound.

Preferred dicarboxylic acids include 2,6-naphthalenedicarboxylic acid, terephthalic acid and isophthalic acid or mixtures thereof. Up to 60 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Among the aliphatic dihydroxy compounds, preference is given to diols having 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol or mixtures thereof.

A first group of preferred polyesters A-1 are polyalkylene terephthalates, in particular those having 2 to 10 carbon atoms in the alcohol portion.

These polyalkylene terephthalates are known per se and are described in the literature. Their main chain comprises an aromatic ring which derives from the aromatic dicarboxylic acid. The aromatic ring may also be substituted, for example by halogen such as chlorine and bromine or by C₁-C₄-alkyl groups such as methyl, ethyl, iso- and n-propyl and n-, iso—or tert-butyl groups.

These polyalkylene terephthalates may be produced by reaction of aromatic dicarboxylic acids, their esters, or other ester-forming derivatives with aliphatic dihydroxy compounds, in a manner known per se.

Particularly preferred polyesters A-1 include polyalkylene terephthalates deriving from alkanediols having 2 to 6 carbon atoms. Among these, particular preference is given to polyethylene terephthalate, polypropylene terephthalate and polybutylene terephthalate or mixtures thereof. Also preferred are PET and/or PBT comprising up to 1% by weight, preferably up to 0.75% by weight, of 1,6-hexanediol and/or 2-methyl-1,5-pentanediol as further monomer units.

The viscosity number (“VN”) of the polyesters A-1 is generally in the range from 50 to 220, preferably from at least 140 ml/g, in particular at least 145 ml/g (measured in a 0.5% by weight solution in a phenol/o-dichlorbenzene mixture (weight ratio 1:1 at 25° C.) according to ISO 1628).

Especially preferred are polyesters whose carboxyl end group content is 0 to 100 mmol/kg, preferably 10 to 50 mmol/kg and in particular 15 to 40 mmol/kg of polyester. Such polyesters may be produced for example by the process of DE-A 44 01 055. The carboxyl end group content is typically determined by titration methods (for example potentiometry).

Especially preferred thermoplastic mixtures comprise as component A-1 a mixture of polyesters, wherein at least one is PBT. The proportion of for example polyethylene terephthalate in the mixture is preferably up to 50%, in particular 10% to 35% by weight, based on 100% by weight of A).

It is further also possible to employ PET recyclates (also known as scrap PET) optionally in admixture with polyalkylene terephthalates such as PBT.

Recyclates are generally understood as meaning:
1) so-called “post-industrial recyclates”: these are production wastes in the polycondensation or in the processing for example of sprues in injection molding, startup scrap in injection molding or extrusion or edge offcuts from extruded sheets or films.
2) so-called “post-consumer recyclate”: these are plastic articles that are collected and processed by the end consumer after use. The quantitatively predominant articles are blow-moulded PET bottles for mineral water, soft drinks and juices.

Both types of recyclate may be in the form of regrind or in the form of pellets. In the latter case, the raw recyclates are melted and pelletized in an extruder after separation and cleaning. This typically facilitates the handling, the pourability and the meterability for further processing steps.

Both pelletized recyclate and recyclate in the form of regrind may be used, wherein the maximum edge length should be 10 mm, preferably less than 8 mm.

Due to the hydrolytic cleavage of polyesters during processing (due to traces of moisture) it is advantageous to pre-dry the recyclates. The residual moisture content after drying should be <0.2%, in particular <0.05%.

Another group which may be mentioned is that of fully aromatic polyesters deriving from aromatic dicarboxylic acids and from aromatic dihydroxy compounds.

Suitable aromatic dicarboxylic acids are the compounds already described for the polyalkylene terephthalates. It is preferable to employ mixtures of 5 to 100 mol % of isophthalic acid and 0 to 100 mol % of terephthalic acid, in particular mixtures comprising from about 80% terephthalic acid with 20% isophthalic acid to approximately equivalent mixtures of these two acids.

The aromatic dihydroxy compounds preferably have the general formula

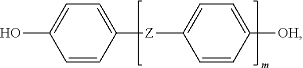

in which Z represents an alkylene or cycloalkylene group having up to 8 carbon atoms, an arylene group having up to 12 carbon atoms, a carbonyl group, a sulfonyl group, an oxygen or sulfur atom or a chemical bond and in which m has a value from 0 to 2. The compounds may also bear C₁-C₆-alkyl or —alkoxy groups and fluorine, chlorine or bromine as substituents.

Parent structures of these compounds include for example
Dihydroxydiphenyl,
Di(hydroxyphenyl)alkane,
Di(hydroxyphenyl)cycloalkane,
Di(hydroxyphenyl)sulfide,
Di(hydroxyphenyl) ether,
Di(hydroxyphenyl)ketone,
Di(hydroxyphenyl) sulfoxide,
α, α′-di-(hydroxyphenyl)dialkylbenzene,
di(hydroxyphenyl)sulfone, di(hydroxybenzoyl)benzene resorcinol and
hydroquinone and their ring-alkylated or ring-halogenated derivatives.

Among these, preference is given to
4,4′-dihydroxydiphenyl,
2,4-di-(4′-hydroxyphenyl)-2-methylbutane,
α, α′-di-(4-hydroxyphenyl)-p-diisopropylbenzene,
2,2-di-(3′-methyl-4′-hydroxyphenyl)propane and
2,2-di-(3′-chloro-4′-hydroxyphenyl)propane,

and in particular
2,2-di-(4′-hydroxyphenyl)propane
2,2-di-(3′,5-dichlorodihydroxyphenyl)propane,
1,1-di-(4′-hydroxyphenyl)cyclohexane,
3,4′-dihydroxybenzophenone,
4,4′-dihydroxydiphenylsulfone and
2,2-di(3′,5′-dimethyl-4′-hydroxyphenyl)propane

or mixtures thereof.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Such products are known per se and described in the literature, for example in US-A 3 651 014. Corresponding products are also commercially available, for example Hytrel® (DuPont).

According to the invention the term “polyesters” is to be understood as also including halogen-free polycarbonates. Suitable halogen-free polycarbonates include for example those based on diphenols of general formula

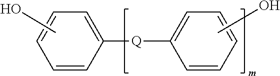

in which Q represents a single bond, a C₁- to C₈-alkylene group, a C₂- to C₃-alkylidene group, a C₃- to C₆-cycloalkylidene group, a C₆- to C₁₂-arylene group or —O—, —S— or —SO₂— and m is an integer from 0 to 2.

The diphenols may also have substituents on the phenylene radicals such as C₁- to C₆-alkyl or C₁- to C₆-alkoxy.

Preferred diphenols of the formula include for example hydroquinone, resorcinol, 4,4′-dihydroxydiphenyl, 2,2-bis(4-hydroxyphenyl)propane, 2,4-bis(4-hydroxyphenyl)-2-methylbutane, 1,1-bis(4-hydroxyphenyl)cyclohexane. Particular preference is given to 2,2-bis(4-hydroxyphenyl)propane and 1,1-bis(4-hydroxyphenyl)cyclohexane and 1,1-bis(4-hydroxyphenyl)-3,3,5-trimethylcyclohexane.

Both homopolycarbonates and copolycarbonates are suitable as component A, preference is given to both bisphenol-A homopolymer and copolycarbonates of bisphenol A.

The suitable polycarbonates may be branched in known fashion, preferably through incorporation of 0.05 to 2.0 mol %, based on the sum of the employed diphenols of at least trifunctional compounds, for example those having three or more than three phenolic OH groups.

Polycarbonates that have proven particularly suitable have relative viscosities ηᵣₑₗ of 1.10 to 1.50, in particular of 1.25 to 1.40. This corresponds to average molecular weights M_{w} (weight average) of 10 000 to 200 000, preferably of 20 000 to 80 000 g/mol.

The diphenols of the general formula are known per se or producible by known processes.

Production of the polycarbonates may be carried out for example by reaction of the diphenols with phosgene by the interfacial process or with phosgene by the homogeneous-phase process (the so-called pyridine process), wherein the molecular weight to be established in each case is achieved in known fashion via an appropriate amount of known chain terminators. (Regarding polydiorganosiloxane-containing polycarbonates see DE-OS 33 34 782 for example).

Suitable chain terminators include for example phenol, p-tert-butylphenol, but also long-chain alkylphenols such as 4-(1,3-tetramethylbutyl)phenol according to DE-OS 28 42 005 or monoalkylphenols or dialkylphenols comprising altogether 8 to 20 carbon atoms in the alkyl substituents according to DE-A 35 06 472, such as p-nonylphenyl, 3,5-di-tert-butylphenol, p-tert-octylphenol, p-dodecylphenol, 2-(3,5-dimethylheptyl)phenol and 4-(3, 5-dimethylheptyl)phenol.

In the context of the present invention the term halogen-free polycarbonates is to be understood as meaning that the polycarbonates are composed of halogen-free diphenols, halogen-free chain terminators and optionally halogen-free branching agents, wherein the content of subordinate ppm amounts of saponifiable chlorine, resulting for example from the production of the polycarbonates with phosgene by the interfacial process, is not to be considered as halogen-containing in the context of the present invention. Such polycarbonates having ppm contents of saponifiable chlorine are halogen-free polycarbonates in the context of the present invention.

Further suitable components A) include amorphous polyester carbonates, wherein phosgene has been replaced by aromatic dicarboxylic acid units such as isophthalic acid and/or terephthalic acid units during production. For further details reference is made at this point to EP-A 711 810.

Further suitable copolycarbonates comprising cycloalkyl radicals as monomer units are described in EP-A 365 916.

As component A-3 the thermoplastic mixtures according to the invention comprise 10% to 25% by weight of an ionomer composed of at least one copolymer of:
3-1) 30% to 99% by weight of ethylene
3-2) 0% to 60% by weight of one or more compounds selected from the group consisting of 1-octene, 1-butene and propylene and
3-3) 0.01% to 50% by weight of one or more functional monomers selected from the group consisting of carboxylic acids, carboxylic anhydrides and carboxylic esters with the proviso that the proportion of carboxylic acids is 30% to 100% by weight, the proportion of carboxylic anhydrides and/or carboxylic esters is complementarily 0% to 70% by weight and the hydrogen of the carboxyl groups of the carboxylic acids is replaced by a metal selected from the group consisting of sodium, potassium and zinc in a proportion of at least 20% (“mol %”) of the total number of carboxyl groups, wherein the proportions of components 3-1, 3-2 and 3-3 sum to 100% by weight.

Preferred metal ions are sodium, potassium or zinc, especially sodium or potassium, or mixtures thereof. The use of sodium is particularly preferred. The percentage neutralization is determinable for example by flame atomic absorption spectrometry using commercially available instruments.

According to R6 mpp Online Lexikon, Georg Thieme Verlag, August 2008 for example, the term ionomers is to be understood as meaning ionic polymers comprising large proportions of hydrophobic monomers and usually small proportions of comonomers bearing ionic groups.

Examples of possible ionomers of components A-3 are also described in the publication EP 0 419 274.

These ionomers are obtainable by direct copolymerization and are converted into salts by means of a subsequent reaction (for example with alkali metal hydroxide solutions for production of the alkali metal-containing ionomers).

Preferred components 3-3 are selected from the group consisting of ethylenically unsaturated monocarboxylic acids, dicarboxylic acids and functional derivatives of these acids.

Such preferred components 3-3 are in particular selected from the group consisting of acrylic acid, methacrylic acid, maleic acid, fumaric acid, maleic anhydride, acrylic esters and methacrylic esters each having 1 to 18 carbon atoms in the alcohol portion of the latter esters.

All primary, secondary and tertiary C₁-C₁₈ alkyl esters of acrylic acid or methacrylic acid are suitable in principle but preference is given to esters having 1 to 12 carbon atoms, in particular having 2 to 10 carbon atoms.

Examples thereof include methyl, ethyl, propyl, n-butyl, isobutyl and tert-butyl, 2-ethylhexyl, octyl and decyl acrylates and the corresponding esters of methacrylic acid. Of these, n-butyl acrylate and 2-ethylhexyl acrylate are considered particularly advantageous.

Instead of the esters or in addition thereto, the olefin polymers may also comprise latently acid-functional monomers of ethylenically unsaturated mono—or dicarboxylic acids.

Examples thereof include as monomers of component 3-3 tertiary alkyl esters of acrylic acid, methacrylic acid, in particular tert-butyl acrylate, tert-butyl methacrylate or dicarboxylic acid derivatives such as monoesters of maleic acid and fumaric acid or derivatives of these acids.

The term “latently acid-functional monomers” is to be understood as meaning compounds which form free acid groups under the polymerization conditions and/or during incorporation of the olefin polymers into the molding materials.

Component A-3 preferably comprises as components
3-1) 50% to 99% by weight of ethylene
3-2) 0% to 50% by weight of one or more compounds selected from the group consisting of 1-octene, 1-butene and propylene and
3-3) 0.05% to 50% by weight of one or more functional monomers selected from the group consisting of carboxylic acids, carboxylic anhydrides and carboxylic esters.

It is further preferable when component A-3 comprises as components
3-1) 50% to 90% by weight of ethylene
3-2) 0% to 50% by weight of one or more compounds selected from the group consisting of 1-octene, 1-butene and propylene and
3-3) 2% to 50% by weight of one or more functional monomers selected from the group consisting of carboxylic acids, carboxylic anhydrides and carboxylic esters.

The production of the above-described ethylene copolymers may be effected by processes known per se, preferably by random copolymerization at high pressure and elevated temperature.

The melt flow index of the ethylene copolymers is generally in the range from 1 to 80 g/10 min (measured at 190° C. under a load of 2.16 kg).

The molecular weight of these ethylene-α-olefin copolymers is between 10 000 and 500 000 g/mol, preferably between 15 000 and 400 000 g/mol (Mn determined by GPC in 1,2,4-trichlorobenzene with polystyrene calibration).

In one particular embodiment ethylene-α-olefin copolymers produced using so-called “single site catalysts” are employed. See U.S. Pat. No. 5,272,236 for further details. In this case the ethylene-α-olefin copolymers have a molecular weight distribution of less than 4, preferably less than 3.5, which is narrow for polyolefins.

As component A-4 the thermoplastic mixtures according to the invention comprise epoxidized oil or oil mixture, in which the at least partially unsaturated fatty acids in the underlying fatty acid esters of the oil or oil mixture have 12 to 22 carbon atoms. Such oils as starting materials for the epoxidation can be of petrochemical, vegetable or animal origin and be present both in pure form and mixed with one another and accordingly be added to the thermoplastic mixtures as pure epoxidized oils or else as mixtures of such epoxidized oils.

Document U.S. Pat. No. 9,034,965 B2 describes in column 2, from line 33 to column 3, line 12 various oils and mixtures thereof which could be subjected to epoxidation. Such epoxidized oils and oil mixtures can also be used according to the invention.

It is preferable to employ epoxidized oils based on vegetable oils selected from the group consisting of soybean oil, linseed oil, rapeseed oil, castor oil, false flax oil, cottonseed oil, olive oil, peanut oil, sunflower oil, corn oil and hemp oil.

Epoxidized oils based on vegetable oils selected from the group consisting of soybean oil, linseed oil, rapeseed oil and castor oil are particularly suitable.

As component B the molding materials according to the invention may comprise 0% to 70% by weight, in particular up to 50% by weight, of further additives and processing aids distinct from component A based on 100% by weight of the sum of components A and B.

Customary additives B include for example amounts of up to 40% by weight, preferably up to 15% by weight, of elastomeric polymers (often also referred to as impact modifiers, elastomers or rubbers).

Examples of impact modifiers include rubbers which may have functional groups. Mixtures of two or more different impact-modifying rubbers may also be employed.

Rubbers that enhance the toughness of the molding materials generally comprise an elastomeric proportion having a glass transition temperature of less than −10° C., preferably of less than −30° C., and comprise at least one functional group capable of reacting with the polyamide. Suitable functional groups include, for example, carboxylic acid, carboxylic anhydride, carboxylic ester, carboxylic amide, carboxylic imide, amino, hydroxyl, epoxide, urethane or oxazoline groups, preferably carboxylic anhydride groups.

Preferred functionalized rubbers include functionalized polyolefin rubbers composed of the following components:
1. 40% to 99% by weight of at least one alpha-olefin having 2 to 8 carbon atoms,
2. 0% to 50% by weight of a diene,
3. 0% to 45% by weight of a C₁-C₁₂-alkyl ester of acrylic acid or methacrylic acid or mixtures of such esters,
4. 0% to 40% by weight of an ethylenically unsaturated C₂-C₂₀-mono—or —dicarboxylic acid or a functional derivative of such an acid,
5. 0% to 40% by weight of an epoxy-comprising monomer and
6. 0% to 5% by weight of other free-radically polymerizable monomers, wherein components 3) to 5) sum to at least 1% to 45% by weight based on components 1) to 6).

Examples of suitable alpha olefins include ethylene, propylene, 1-butylene, 1-pentylene, 1-hexylene, 1-heptylene, 1-octylene, 2-methylpropylene, 3-methyl-1-butylene and 3-ethyl-1-butylene, preference being given to ethylene and propylene.

Suitable diene monomers include, for example, conjugated dienes having 4 to 8 carbon atoms, such as isoprene and butadiene, nonconjugated dienes having 5 to 25 carbon atoms, such as penta-1,4-diene, hexa-1,4-diene, hexa-1,5-diene, 2,5-dimethylhexa-1,5-diene and octa-1,4-diene, cyclic dienes, such as cyclopentadiene, cyclohexadienes, cyclooctadienes and dicyclopentadiene, and alkenylnorbornenes, such as 5-ethylidene-2-norbornene, 5-butylidene-2-norbornene, 2-methallyl-5-norbornene, 2-isopropenyl-5-norbornene, and tricyclodienes, such as 3-methyltricyclo[5.2.1.0.2.6]-3,8-decadiene, or mixtures thereof. Preference is given to hexa-1,5-diene, 5-ethylidenenorbornene and dicyclopentadiene.

The diene content is preferably 0.5% to 50%, in particular 2% to 20% and particularly preferably 3% to 15% by weight based on the total weight of the olefin polymer. Examples of suitable esters include methyl, ethyl, propyl, n-butyl, i-butyl, 2-ethylhexyl, octyl and decyl acrylates/the corresponding esters of methacrylic acid. Of these, particular preference is given to methyl, ethyl, propyl, n-butyl and 2-ethylhexyl acrylate/methacrylate. Instead of the esters or in addition thereto, the olefin polymers may also comprise acid-functional and/or latently acid-functional monomers of ethylenically unsaturated mono—or dicarboxylic acids.

Examples of ethylenically unsaturated mono—or dicarboxylic acids include acrylic acid, methacrylic acid, tertiary alkyl esters of these acids, in particular tert-butyl acrylate, and dicarboxylic acids, such as maleic acid and fumaric acid, or derivatives of these acids and also the monoesters thereof.

“Latently acid-functional monomers” is to be understood as meaning compounds which form free acid groups under the polymerization conditions or during incorporation of the olefin polymers into the molding materials. Examples thereof include anhydrides of dicarboxylic acids having 2 to 20 carbon atoms, in particular maleic anhydride and tertiary C₁-C₁₂ alkyl esters of the abovementioned acids, in particular tert-butyl acrylate and tert-butyl methacrylate.

Useful other monomers include, for example, vinyl esters and vinyl ethers.

Particular preference is given to olefin polymers composed of 50% to 98.9% by weight, in particular 60% to 94.85% by weight, of ethylene and 1% to 50% by weight, in particular 5% to 40% by weight, of an ester of acrylic or methacrylic acid, 0.1% to 20.0% by weight, in particular 0.15% to 15% by weight, of glycidyl acrylate and/or glycidyl methacrylate, acrylic acid and/or maleic anhydride.

Particularly suitable functionalized rubbers are ethylene-methyl methacrylate-glycidyl methacrylate, ethylene-methyl acrylate-glycidyl methacrylate, ethylene-methyl acrylate-glycidyl acrylate and ethylene-methyl methacrylate-glycidyl acrylate polymers.

The production of the above described polymers may be effected by processes known per se, preferably by random copolymerization under high pressure and elevated temperature. The melt flow index of these copolymers is generally in the range from 1 to 80 g/10 min (measured at 190° C. under a load of 2.16 kg).

A further group of suitable rubbers are core-shell graft rubbers. These are graft rubbers produced in emulsion which are composed of at least one hard and one soft constituent. A hard constituent is typically a polymer having a glass transition temperature of at least 25° C., while a soft constituent is a polymer having a glass transition temperature of not higher than 0° C. These products have a structure composed of a core and at least one shell, the structure being the result of the order in which the monomers are added. The soft constituents are generally derived from butadiene, isoprene, alkyl acrylates, alkyl methacrylates or siloxanes and optionally further comonomers. Suitable siloxane cores may be produced, for example, starting from cyclic oligomeric octamethyltetrasiloxane or tetravinyltetramethyltetrasiloxane. These may be reacted, for example, with gamma-mercaptopropylmethyldimethoxysilane in a ring-opening cationic polymerization, preferably in the presence of sulfonic acids, to form the soft siloxane cores. The siloxanes may also be crosslinked by, for example, conducting the polymerization reaction in the presence of silanes having hydrolyzable groups such as halogen or alkoxy groups such as tetraethoxysilane, methyltrimethoxysilane or phenyltrimethoxysilane. Suitable comonomers here include, for example, styrene, acrylonitrile and crosslinking or grafting monomers having more than one polymerizable double bond such as diallyl phthalate, divinylbenzene, butanediol diacrylate or triallyl(iso)cyanurate. The hard constituents are generally derived from styrene, alpha-methylstyrene and copolymers thereof, preferred comonomers being acrylonitrile, methacrylonitrile and methyl methacrylate.

Preferred core-shell graft rubbers comprise a soft core and a hard shell or a hard core, a first soft shell and at least one further hard shell. The incorporation of functional groups such as carbonyl, carboxylic acid, acid anhydride, acid amide, acid imide, carboxylic ester, amino, hydroxyl, epoxy, oxazoline, urethane, urea, lactam or halobenzyl groups is here preferably effected by the addition of suitably functionalized monomers during the polymerization of the last shell. Suitable functionalized monomers include, for example, maleic acid, maleic anhydride, mono—or diesters of maleic acid, tert-butyl (meth)acrylate, acrylic acid, glycidyl (meth)acrylate and vinyloxazoline. The proportion of monomers having functional groups is generally 0.1% to 25% by weight, preferably 0.25% to 15% by weight, based on the total weight of the core-shell graft rubber. The weight ratio of soft to hard constituents is generally 1:9 to 9:1, preferably 3:7 to 8:2.

Such rubbers are known per se and described in the publication EP 0 208 187 for example. The incorporation of oxazine groups for functionalization may be effected, for example, according to EP 0 791 606.

A further group of suitable impact modifiers are thermoplastic polyester elastomers. Polyester elastomers are segmented copolyether esters comprising long-chain segments, generally derived from poly(alkylene) ether glycols, and short-chain segments deriving from low molecular weight diols and dicarboxylic acids. Such products are known per se and described in the literature, for example in U.S. Pat. No. 3,651,014. Corresponding products are also commercially available under the names Hytrel™ (Du Pont), Arnitel™ (Akzo) and Pelprene™ (Toyobo Co. Ltd.).

It will be appreciated that it is also possible to use mixtures of different rubbers.

Additives of components B that may be added include fibrous or particulate fillers, for instance glass fibers, glass beads, amorphous silica, calcium silicate, calcium metasilicate, magnesium carbonate, kaolin, chalk, powdered quartz, mica, barium sulfate and feldspar.

Fibrous fillers B are employed in amounts of up to 60% by weight, in particular up to 35% by weight, and particulate fillers are employed in amounts of up to 30% by weight, in particular up to 10% by weight, based on the total mixture of the thermoplastic mixture.

Preferred fibrous fillers include aramid fibers, and potassium titanate fibers, wherein glass fibers in the form of E-glass are particularly preferred. These may be employed as rovings or chopped glass in the commercially available forms.

Laser-absorbing materials such as carbon fibers, carbon black, graphite, graphene or carbon nanotubes are also suitable as fillers. These are preferably employed in the particular case in amounts of less than 1% by weight, particularly preferably less than 0.05% by weight.

The fibrous fillers may have been subjected to a surficial pretreatment with a silane compound for better compatibility with the thermoplastic. Suitable silane compounds are those of general formula

(X—(CH₂)ₙ)ₖSi—(O—CₘH₂ₘ₊₁)₄₋ₖ

in which the substituents are defined as follows:

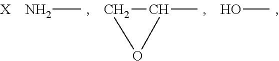

n an integer from 2 to 10, preferably from 3 to 4
m an integer from 1 to 5, preferably from 1 to 2
k an integer from 1 to 3, preferably 1.

Preferred silane compounds are aminopropyltrimethoxysilane, aminobutyltrimethoxysilane, aminopropyltriethoxysilane, aminobutyltriethoxysilane and also the corresponding silanes which comprise a glycidyl group as substituent X.

The silane compounds are generally employed for surface coating in amounts of 0.05% to 5%, preferably 0.1% to 1.5% and in particular 0.2% to 0.5% by weight (based on component B)).

Acicular mineral fillers are also suitable.

In the context of the invention acicular mineral fillers are to be understood as meaning a mineral filler having distinctly acicular character. One example is acicular wollastonite. The L/D (length to diameter) ratio of the mineral is preferably 8:1 to 35:1, preferably from 8:1 to 11:1. The mineral filler may optionally have been pretreated with the abovementioned silane compounds but pretreatment is not an essential requirement.

As component B the thermoplastic molding compounds according to the invention may comprise customary processing aids such as stabilizers, oxidation retarders, agents to counteract thermal degradation and ultraviolet light degradation, glidants and mold release agents, nucleating agents such as sodium phenylphosphinate, aluminium oxide, silicon dioxide, nylon 22 and colorants such as dyes and pigments or plasticizers etc.

The thermoplastic mixtures according to the invention comprise 0% to 5% by weight of talc as the preferred nucleating agent B. This is preferably employed in amounts of 0.001% to 4% by weight, in particular of 0.01% to 1% by weight.

Talc is a hydrated magnesium silicate in which other trace elements such as for example Mn, Ti, Cr, Ni, Na and K may be present and OH groups may be replaced by fluoride.

It is particularly preferable to employ talc which, to an extent of 100%, has particle sizes of less than 20 μm. The particle size distribution is typically determined by sedimentation analysis and is preferably <20 μm: 100% by weight, <10 μm: 99% by weight, <5 μm: 85% by weight, <3 μm: 60% by weight, <2 μm: 43% by weight. Such products are commercially available as Micro-Talc I.T. extra.

Examples of oxidation retarders and heat stabilizers are sterically hindered phenols and/or phosphites, hydroquinones, aromatic secondary amines such as diphenylamines, various substituted representatives of these groups and mixtures thereof in concentrations of up to 1% by weight based on the weight of the thermoplastic molding materials.

Examples of UV stabilizers, which are generally employed in amounts of up to 2% by weight based on the molding material, include various substituted resorcinols, salicylates, benzotriazoles and benzophenones.

Inorganic and organic pigments and dyes such as nigrosin and anthraquinones may be added as colorants. Particularly suitable colorants are recited in EP 1 722 984 B1, EP 1 353 986 B1 or DE 10054859 A1 for example.

As additives of components B (“lubricants, glidants and mold release agents”) the thermoplastic mixtures according to the invention may comprise esters or amides of saturated or unsaturated aliphatic carboxylic acids having 10 to 40, preferably 16 to 22, carbon atoms with aliphatic saturated alcohols or amines having 2 to 40, preferably 2 to 6, carbon atoms.

The carboxylic acids may be mono—or dibasic. Examples include pelargonic acid, palmitic acid, lauric acid, margaric acid, dodecanedioic acid, behenic acid, and particularly preferably stearic acid, capric acid and montanic acid (mixture of fatty acids having from 30 to 40 carbon atoms).

The aliphatic alcohols may be mono- to tetrahydric. Examples of alcohols include n-butanol, n-octanol, stearyl alcohol, ethylene glycol, propylene glycol, neopentyl glycol, and pentaerythritol, preference being given here to glycerol and pentaerythritol.

The aliphatic amines may be mono- to trifunctional. Examples thereof are stearylamine, ethylenediamine, propylenediamine, hexamethylenediamine, and di(6-aminohexyl)amine, wherein ethylenediamine and hexamethylenediamine are particularly preferred. Preferred esters or amides are correspondingly glyceryl distearate, glyceryl tristearate, ethylenediamine distearate, glyceryl monopalmitate, glyceryl trilaurate, glyceryl monobehenate and pentaerythrityl tetrastearate.

It is also possible to use mixtures of different esters or amides or esters combined with amides in any desired mixing ratio.

Polyether polyols or polyester polyols esterified or etherified with monobasic or polybasic carboxylic acids, preferably fatty acids, are also suitable. Suitable products are commercially available, for example as Loxiol® EP 728 from Henkel KGaA.

Preferred ethers deriving from alcohols and ethylene oxide have the general formula

RO(CH₂CH₂O)ₙH

in which R is an alkyl group having 6 to 40 carbon atoms and n is an integer of greater than or equal to 1. An especially preferred R is a saturated C₁₆- to C₁₈-fatty alcohol where n is about 50 which is commercially available as Lutensol® AT 50 from BASF.

Further examples of such additives (“lubricants, glidants and mold release agents”) are long-chain fatty acids (for example stearic acid or behenic acid), salts thereof (for example Ca or Zn stearate) or montan waxes (mixtures of straight-chain, saturated carboxylic acids having chain lengths of 28 to 32 carbon atoms) and Ca or Na montanate and low molecular weight polyethylene or polypropylene waxes.

The abovementioned additives of component B (“lubricants, glidants and mold release agents”) are typically employed in amounts of up to 1% by weight based on the total mixture.

Examples of plasticizers as additives of component B are dioctyl phthalate, dibenzyl phthalate, butylbenzyl phthalate, hydrocarbon oils and N-(n-butyl)benzenesulfonamide.

The molding materials according to the invention may also comprise 0% to 2% by weight of fluorine-containing ethylene polymers. These are polymers of ethylene having a fluorine content of 55% to 76% by weight, preferably 70% to 76% by weight.

Examples thereof include polytetrafluoroethylene (PTFE), tetrafluoroethylene-hexafluoropropylene copolymers or tetrafluoroethylene copolymers comprising smaller proportions (generally up to 50% by weight) of copolymerizable ethylenically unsaturated monomers. These are described, for example, by Schildknecht in “Vinyl and Related Polymers”, Wiley-Verlag, 1952, pages 484 to 494, and by Wall in “Fluoropolymers” (Wiley Interscience, 1972).

These fluorine-containing ethylene polymers are homogeneously distributed in the molding materials and preferably have a particle size d₅₀ (number average) in the range from 0.05 to 10 μm, in particular from 0.1 to 5 μm. These small particle sizes are particularly preferably achievable through the use of aqueous dispersions of fluorine-containing ethylene polymers and the incorporation thereof into a polymer melt.

The thermoplastic mixtures according to the invention may be produced by processes known per se by mixing the starting components A-1, A-2, A-3 and B in customary mixing apparatuses such as (twin-)screw extruders, Brabender mills or Banbury mills and subsequently extruded. After extrusion the extrudate may be cooled and comminuted. It is also possible to premix individual components and then add the remaining starting materials individually and/or likewise in admixture. The mixing temperatures are generally around 230′ C to 320′ C. In particular, individual components, for example A-3 and/or B, can also be added as “hot feed” or directly into the feed section of the extruder.

Also claimed in the context of the present application are moldings and hollow bodies produced using thermoplastic mixtures according to the invention. Claimed in particular are hollow bodies produced using the thermoplastic mixtures according to the invention by blow molding processes, for example extrusion blow molding and stretch blow molding.

### EXAMPLES

### I. Starting Materials:

Component A-1:
Polybutylene terephthalate (Ultradur® B 6550 from BASF SE)

| | |
|---|---|
| Characterization: | |
| Carboxyl end group | 34 mmol/kg |
| content: | |
| Viscosity: | 160 ml/g (VN measured in a 0.5% by weight |
| | solution of phenol/o-dichlorobenzene, 1:1 |
| | mixture at 25° C. according to ISO 1628) |
| Melt Volume Rate: | 9.5 cm³/10 min (measured according to ISO 1133 |
| | at 250° C. and 2.16 kg) |

Component A-2:
HDPE HTA 108 (ExxonMobil*)

| | |
|---|---|
| Characterization: | |
| Density: | 0.961 g/cm3 (according to ASTM D1505) |
| Melt Index (190° C./ | 0.70 g/10 min (according to ASTM |
| 2.16 kg): | D1238) |
| Melt Mass Flow Rate (MFR): | 46 g/10 min (according to ASTM D1238) |

Component A-3:
SURLYN® 1707 (The Dow Chemical Company)

### Characterization:

An ionomer of an ethylene-acrylic acid copolymer which is 80% neutralized with sodium ions. The acrylic acid content is 15%.

### Component A-4

Epoxidized linseed oil (TRANSFORMACIONES QUIMICO—INDUSTRIALES, S.L. —TRAQUISA)

Characterization by percentage proportions of the fatty acids (in % by weight):
Stearic acid: 3-5
Palmitic acid: 5-7
Oleic acid (monounsaturated): 18-26
Linoleic acid (diunsaturated): 14-20
Linolenic acid (triunsaturated): 51-56 (epoxidized linseed oil will be abbreviated below to ELO — Epoxidized Linseed Oil)

### II. Sample Preparation:

Mixtures of Ultradur® B6550 (component A-1), HDPE HTA108 (component A-2) and Surlyn® 1707 (component A-3) were mixed in pellet form in the proportions (% by weight) reported in Table 1 below and dried overnight at 80° C. This mixture was fed into a twin-screw extruder (CTW100, Thermo Fischer Polylab QC) which is fitted by the manufacturer with screws for intensive mixing. ELO (component A-4) was added to the mixtures of components A-1, A-2 and A-3 in liquid form. The extruder was operated at a speed of 140 rpm at a nominal 250° C. The melting temperature was determined as about 260° C. The extrudate was cooled in a water bath and pelletized. The pellet material obtained was provided for Rheotens analysis.

### III. Measurement Procedure:

The melt volume rates of samples C1, C2 and E1 to E6 were measured according to ISO 113 at 250° C. and 2.16 kg.

### IV. Measured Results:

In accordance with the abovementioned standard ISO 1133 the melt volume rate (MVR-Melt Volume-Flow Rate) values were determined for various thermoplastic mixtures. The compositions of comparative examples C1 and C2 show the results for a thermoplastic mixture of components A-1, A-2 and A-3 without component A-4 (see prior art D5 cited at the outset) and for a thermoplastic mixture of only components A-1 and A-4. By contrast, examples E1 to E6 comprise thermoplastic mixtures according to the invention.

TABLE 1

| Example | Ultradur ® B6550 | HDPE HTA 108 | Surlyn ® 1707 | ELO | MVR (cm³/10 min) |
|---|---|---|---|---|---|
| C1 | 70 | 20 | 10 | 0 | 32.7 |
| C2 | 99 | 0 | 0 | 1 | 68.6 |
| E1 | 69 | 20 | 10 | 1 | 4.9 |
| E2 | 68 | 20 | 10 | 2 | 3 |
| E3 | 70.5 | 20 | 7.5 | 2 | 2.5 |
| E4 | 69.5 | 20 | 7.5 | 3 | 1.8 |
| E5 | 73 | 20 | 5 | 2 | 3 |
| E6 | 72 | 20 | 5 | 3 | 1.6 |

While the MVR values for the comparative examples C1 and C2 are above 30 cm³/10 min and therefore exhibit comparatively highly mobile characteristics, the inventive thermoplastic mixtures E1 to E6 without exception exhibit values of below 5 cm³/10 min. Since the measurement procedure (point Ill.) is especially directed to the flow characteristics of the thermoplastic mixtures it may be assumed that the properties of the inventive thermoplastic mixtures are also reflected in processing by shaping processes, for example blow molding. In the case of the inventive thermoplastic mixtures it may be assumed that the occurrence of undesired, rapid tearing of the melt strand (“flow/drip-away of the thermoplastic mixture”) during processing is efficiently reduced.

1. A thermoplastic mixture comprising:
A) 30% to 100% by weight of a thermoplastic blend consisting of:
A-1) 65% to 75% by weight of a polyester,
A-2) 5% to 25% by weight of an HD or LD polyethylene,
A-3) 3% to 10% by weight of an ionomer composed of at least one copolymer of:
3-1) 30% to 99% by weight of ethylene
3-2) 0% to 60% by weight of one or compound selected from the group consisting of 1-octene, 1-butene, and propylene and
3-3) 0.01% to 50% by weight of one or more functional monomer selected from the group consisting of carboxylic acids, carboxylic anhydrides, and carboxylic esters with the proviso that the proportion of carboxylic acids is 30% to 100% by weight, the proportion of carboxylic anhydrides and/or carboxylic esters is complementarily 0% to 70% by weight and the hydrogen of the carboxyl groups of the carboxylic acids is replaced by a metal selected from the group consisting of sodium, potassium, and zinc in a proportion of at least 20% (“mol %”) of the total number of carboxyl groups,
wherein proportions of components 3-1, 3-2, and 3-3 sum to 100% by weight,
A-4) 0.5% to 5% by weight of an epoxidized oil or oil mixture, in which the at least partially unsaturated fatty acids in the underlying fatty acid esters of the oil or oil mixture have 12 to 22 carbon atoms,
wherein proportions of components A-1, A-2, A-3, and A-4 sum to 100% by weight of component A),
B) 0 to 70% by weight of further additives,
wherein the proportions of components A) and B) sum to 100% by weight.

2. The thermoplastic mixture according to claim 1, in which in component 3-3 of A-3 the hydrogen of the carboxyl groups of the carboxylic acids is replaced by a metal selected from the group consisting of sodium, potassium, and zinc in a proportion of at least 50% (“mol %”) of the total number of carboxyl groups,

3. The thermoplastic mixture according to claim 1, in which the metal in component 3-3 of A-3 is sodium, potassium, or a mixture of both in any ratio.

4. The thermoplastic mixture according to claim 1, in which the proportion of component A-1 is 68% to 73% by weight, the proportion of component A-2 is 18% to 22% by weight, the proportion of component A-3 is 5% to 10% by weight, and the proportion of component A-4 is 2% to 5% by weight.

5. The thermoplastic mixture according to claim 1, in which component A has a carboxyl end group content of 10 to 50 mmol/kg of polyester.

6. The thermoplastic mixture according to claim 1, in which the one or more functional monomer of component 3-3 of A-3 is selected from the group consisting of ethylenically unsaturated monocarboxylic acids, dicarboxylic acids, and functional derivatives of these acids.

7. The thermoplastic mixture according to claim 1, in which the one or more functional monomer of component 3-3 of A-3 is selected from the group consisting of acrylic acid, methacrylic acid, maleic acid, fumaric acid, maleic anhydride, acrylic esters, and methacrylic esters each having 1 to 18 carbon atoms in the alcohol portion of the latter esters.

8. The thermoplastic mixture according to claim 1, in which component A-3 comprises
3-1) 50% to 99% by weight of ethylene
3-2) 0% to 50% by weight of one or more compound selected from the group consisting of 1-octene, 1-butene, and propylene and
3-3) 0.05% to 50% by weight of one or more functional monomer selected from the group consisting of carboxylic acids, carboxylic anhydrides, and carboxylic esters.

9. The thermoplastic mixture according to claim 1, in which component A-3 comprises
3-1) 50% to 90% by weight of ethylene
3-2) 0% to 50% by weight of one or more compound selected from the group consisting of 1-octene, 1-butene, and propylene and
3-3) 2% to 50% by weight of one or more functional monomer selected from the group consisting of carboxylic acids, carboxylic anhydrides, and carboxylic esters.

10. The thermoplastic mixture according to claim 1, in which the epoxidized oil or mixture of component A-4 is derived from one or more vegetable oil selected from the group consisting of soybean oil, linseed oil, rapeseed oil, false flax oil, castor oil, cottonseed oil, olive oil, peanut oil, sunflower oil, corn oil, and hemp oil.

11. The thermoplastic mixture according to claim 10, in which the epoxidized oil or oil mixture of component A-4 is derived from one or more vegetable oil selected from the group consisting of soybean oil, linseed oil, rapeseed oil, and castor oil.

12. The thermoplastic mixture according to claim 1, in which the proportion of component A-4 is 1% to 3% by weight.

13. A molding produced from a thermoplastic mixture according to claim 1.

14. A hollow body produced from a thermoplastic mixture according to claim 1.

15. A hollow body produced by a blow molding process from a thermoplastic mixture according to claim 1.
